(19) United States
(12) Patent Application Publication
(10) Pub. No.: US 2002/0056511 A1
(43) Pub. Date: May 16, 2002

(54) Method of making fluorocarbon coated braided hose assemblies

(76) Inventors: Boney Mathew, Clarkston, MI (US); Norman S. Martucci, Clarkston, MI (US)

Correspondence Address: Amy E. Rinaldo, Kohn & Associates, 30500 Northwestern Highway, Suite 410, Farmington Hills, MI, 48334, US

(21) Appl. No.: 09/494,837

(22) Filed: Jan. 31, 2000

Related U.S. Application Data
(63) Continuation-in-part of application No. 08/931,018, filed on Sep. 15, 1997, now abandoned.
Application No. 08/931,018 is a continuation of application No. 08/259,343, filed on Jun. 14, 1994, now abandoned.
Application No. 08/259,343 is a continuation of application No. 08/023,417, filed on Feb. 23, 1993, now abandoned.
Application No. 08/023,417 is a continuation-in-part of application No. 07/764,460, filed on Sep. 24, 1991, now abandoned.

(51) Int. Cl. B32B 1/00; D03D 1/00

(52) U.S. Cl. 156/244.13; 156/244.24; 156/307.1

(57) ABSTRACT

A method of making a lightweight hose assembly (10) of the type adapted for carrying fuels and other corrosive fluids. The method includes the steps of extruding an inner tubular liner (12) of a fluorocarbon material. Glass fibers are then braided about the exterior of the liner (12) to form a braided layer (13). The inner tubular liner (12) and braided layer (13) are then passed through a reservoir containing a dispersion including a fluorocarbon polymer material, carrying agent, and surfactant therein. The surfactant distributes the fluorocarbon material throughout the braided layer (13) and about the inner liner (12). Subsequently, the assembly (10) is heated to remove the carrying agent and surfactant therefrom. The assembly (10) is then sintered to cure the fluorocarbon polymer material into a coating (14) dispersed throughout the braided layer (13) and about the inner liner (12).

### BACKGROUND OF THE INVENTION

1). Technical Field

The subject invention relates to a method for constructing hose assemblies. More specifically, the subject invention relates to a method for constructing hose assemblies having an inner fluorocarbon liner supported within a glass braided layer. The glass braided layer includes a fluorocarbon polymer coating dispersed therethrough.

2. Description of the Related Art

Hose assemblies used for carrying fuels are well-known in the art. Such hose assemblies should preferably be strong and resistant to heat and chemical degradation. These hoses are subject to chemical breakdown due to exposure to the various fuels which flow through them. Further, these hoses are typically routed through the engine compartments of vehicles to deliver fuel to the engines. These engines are hot and thus, the hoses used to carry fuels are subject to thermal breakdown from the heat.

TEFLON hoses provide the necessary physical properties for carrying fuels. A major drawback with these types of hoses however, is that when used alone, i.e., only a TEFLON-liner or conduit, they tend to become bent during installation resulting in a kink. This kink or deformation remains permanent and provides constant resistance to fluid flow through the hose. To solve this problem, hose assemblies have been constructed which include an inner TEFLON tubular member surrounded by a tightly wound metallic braid. The metallic braid allows the TEFLON inner tubular member to bend to a certain degree without kinking. However, if bent past a certain point, the metallic braid aids in the kinking of the inner tubular member. This type of assembly has three major disadvantages. First, the metallic braid tends to abraid the exterior of the inner tubular member. This causes leaks from the inner tubular member. The second problem is that the exterior metallic braided casing is thermally and electrically conductive. More important is that the metallic braid will retain heat and transfer the heat to the fuel moving through the inner tubular member causing fuel system problems. Finally, when used in an automotive environment, the metallic braid transmits noise during operation of the vehicle which is undesirable.

To avoid the problems associated with metallic braided layers, the inner tubular member may be supported within non-metallic braided material. Although the substitution of non-metallic braiding material avoids many problems associated with metallic braiding, several problems exist. First, hose kinking remains a problem due to relative longitudinal movement between the inner tubular member and the braided layer. That is, due to relative slippage between the inner tubular member and the braided layer, the hose assembly is susceptible to kinking. Second, the hose assembly is usually exposed to external heat and chemicals and thus must be resistant to heat and chemical degradation. Most non-metallic braiding materials do not provide the requisite heat or chemical resistance required. Third, hose assemblies generally encounter rough surfaces after installation; that is, they rub up against engine components. Accordingly, due to exposure to frictional movement, the hose assembly must be resistant to abrasion.

Copending application U.S. Ser. No. 657,084 filed Feb. 19, 1991 and its copending divisional application U.S. Ser. No. 416,151 filed Oct. 2, 1989 (which is a continuation-in-part of U.S. Ser. No. 305,643 filed Feb. 2, 1989 and now abandoned), which are all assigned to the assignee of the subject invention, disclose a method for making a coated, braided hose assembly. The method comprises the steps of extruding an inner tubular liner of a polymeric fluorocarbon material and subsequently braiding glass fibers about the exterior of the liner. The inner tubular liner and the braided layer are then passed through a reservoir containing an aqueous solution of a fluorocarbon polymer. The solvent water is later removed from the hose assembly, leaving a fluorocarbon polymer coating dispersed throughout the braided layer.

Copending application U.S. Ser. No. 535,734, filed Jun. 11, 1990, is a continuation-in-part of U.S. Ser. No. 244,319 filed Sep. 8, 1988, now abandoned, and discloses a hose assembly comprising an inner tubular liner of a fluorocarbon polymer including a fabric braided layer disposed thereabout. An outer foam layer may be disposed about the braided layer. The assembly additionally includes a conductive strip formed on the inner liner for dissipating electrical charges accumulating along the inner liner.

U.S. Pat. No. 4,311,547 to Biggs et al discloses a hose assembly including an inner rubber liner having a reinforcement layer braided therearound. A solidifiable liquid polymer is embedded into the interstices of the reinforcement layer so as to bond the inner rubber liner to the reinforcement layer braided thereabout. The solidifiable liquid polymer may comprise plastisol, aldehide, epoxy, or isocyanate resins. A cover layer may be disposed about the reinforcement layer and bonded thereto by the solidifiable liquid polymer. The cover layer may comprise the same material as that which unites the reinforcement layer and the inner liner, that is, in addition to bonding the inner rubber liner to the reinforcement layer, the solidifiable liquid polymer may also act as the cover layer. Although the solidifiable liquid polymer does in fact bond the inner liner to the reinforcement layer disposed thereabout, it does not sufficiently resist abrasion, and heat and chemical degradation.

U.S. Pat. No. 4,215,384 to Elson discloses a hose construction and method for making the same. The hose assembly includes an inner organic polymeric liner having a braided material disposed thereover. The assembly further includes an outer coating of an organic polymeric material. A conductive strip is disposed within the inner tubular liner for conducting electrical charges throughout the interior of the liner. The assembly further includes end fittings on each end of the inner liner for allowing fluid to be conducted therethrough.

U.S. Pat. No. 4,007,070 to Busdiecker discloses a hose construction having an inner polymeric liner. The liner has a braided layer disposed thereover. An outer protective layer constructed from an organic polymeric material is disposed about the exterior of the braided layer. The Busdiecker '070 patent discloses the use of an adhesive to bond the inner liner to the braided material. The adhesive also coats the braided material for securing the braided material to an outer protective layer.

U.S. Pat. No. 4,394,705 to Blachman discloses a hose assembly including an inner fluorocarbon liner including a reinforcing braided layer disposed thereabout. A cover layer having chemical and abrasion resistant properties is disposed about the braided layer thus protecting the inner liner and braided layer.

### SUMMARY OF THE INVENTION AND ADVANTAGES

The present invention is a method for constructing a hose assembly comprising the steps of: providing an inner tubular liner of a fluorocarbon polymer and positioning a braided layer about the exterior of the inner tubular liner. The method is characterized by the steps of: applying a dispersion, including a fluorocarbon polymer material therein, to the braided layer and the inner tubular liner and applying a surfactant to the hose assembly for distributing the dispersion throughout the braided layer and about the inner tubular liner.

An advantage of applying a dispersion having a fluorocarbon polymer material therein is realized by the resulting hose assembly's resistance to heat and abrasion degradation.

An advantage of applying a surfactant to the hose assembly is realized by a more even distribution of the dispersion throughout the braided layer and about the inner tubular liner. This results in a stronger bond between the inner tubular liner and the braided layer disposed thereabout. Thus, the hose assembly is more resistant to kinking. Additionally, due to the more even distribution of the dispersion, the resulting hose assembly is more resistant to abrasion and heat and chemical degradation.

### BRIEF DESCRIPTION OF THE DRAWINGS

Other advantages of the subject invention will be readily appreciated when the same becomes better understood by reference to the following detailed description when considered in connection with the accompanying drawings wherein:

FIG. 1 is a perspective view of the preferred embodiment of the subject invention;

FIG. 2 is a side view partially broken away of the preferred embodiment of the subject invention including a coupler member;

FIG. 3 is a side view partially broken away of the preferred embodiment of the subject invention including an alternative coupling member; and

FIG. 4 is an enlarged cross-sectional view of a hose assembly.

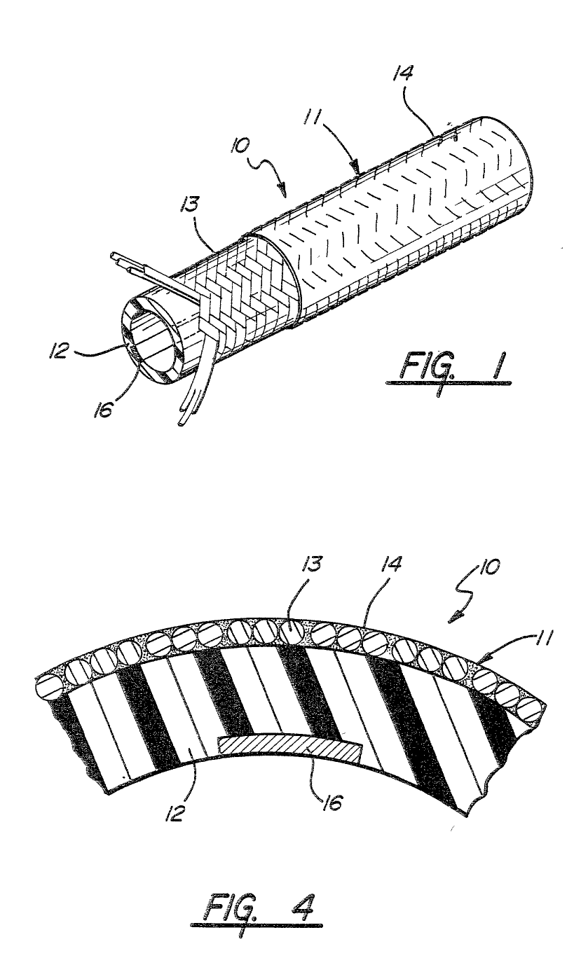

### DETAILED DESCRIPTION OF THE PREFERRED EMBODIMENT

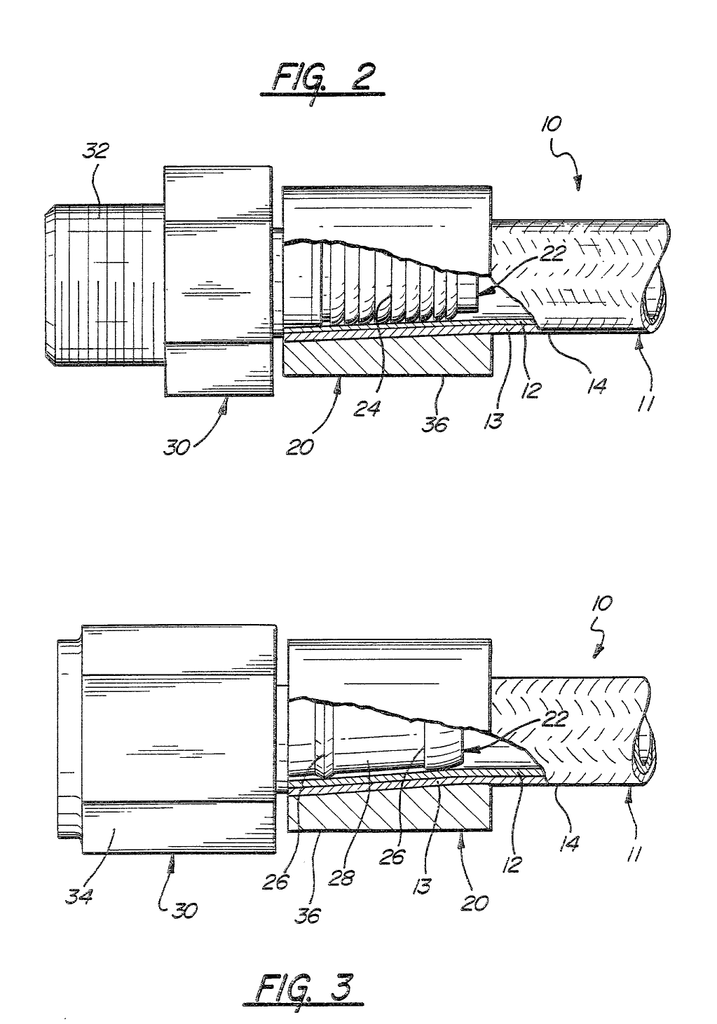

A hose assembly, made in accordance with the subject invention is generally shown at 10 in the Figures. The assembly 10 includes a tubular member generally indicated at 11 and coupling means, generally indicated at 20 (as best viewed in FIGS. 2 and 3), for connecting the ends of the tubular member 11 to fittings for conducting fluid therethrough.

The tubular member 11 includes an inner organic, polymeric liner 12. The liner 12 is preferably extruded and has a wall thickness between 0.001 and 0.120 inches. The inner liner 12 is preferably made of a fluorocarbon polymer. Specifically, the inner liner is preferably made from the polymer of tetrafluoroethylene (PTFE), the polymer of fluorinated ethylene propylene (FEP), the polymer of perfluoroalkoxy resin (PFA), or the polymer of ethylene-tetrafluoroethylene (ETFE). The fluorocarbon polymers PTFE, FEP, and PFA are sold under the trademark TEFLON by DuPont. The polymer ETFE is sold under the trademark TEFZEL by DuPont.

The inner liner 12 is impervious to fluid flow through the wall. Since the inner liner 12 is preferably made of a fluorocarbon polymer material, it is resistant to both heat and chemical degradation. This allows a variety of fluids, particularly vehicle fuels, to pass through the interior of the liner 12 without corroding the liner 12.

The assembly 10 further includes a braided or woven layer 13 disposed about the exterior of the inner liner 12. The braided or woven layer 13 can comprise any non-metallic material disposed in interleaving fashion or wrapped tightly about the inner liner 12. Preferably, the material used for the braided layer 13 is a glass fiber. Glass fibers provide the hose assembly 10 with the necessary strength. Further, glass fibers are heat resistant which is important for hose applications in heated environments and for making the subject hose assembly as will be described subsequently.

The braided or woven fibers may be tightly wound or they may be loosely wound about the inner liner 12, having wide gaps between adjacent fibers. In the preferred embodiment, the glass fibers are tightly woven such that the gaps or spaces between adjacent fibers is minimal. The braided layer 13 adds to the strength of the inner liner 12. Particularly, by using a braided layer 13, the working pressure of the inner liner 12 is increased, allowing a higher pressure of fluid to flow through the inner liner 12. Further, the braided layer 13 adds to the tensile strength of the hose assembly 10. When coupling members 20 are disposed on the ends of the tubular member 11, as will be described subsequently, the braided layer 13 increases the tensile strength of the hose assembly 10 sufficiently to fixedly connect any type of coupling member 20 to the tubular member 11. Finally, the braided layer adds to the hoop strength of the inner liner 12.

The assembly 10 further includes a fluorocarbon polymer coating 14 dispersed throughout the braided layer 13 and about the inner liner 12. That is, the coating 14 is distributed within the interstices of the braided layer 13 forming a single layer therewith. The coating 14 is located from the outer periphery of the braided layer 13 radially inward toward the inner liner 12 (best shown at FIG. 4). Preferably, the fluorocarbon polymer coating 14 is one of the following: the polymer of tetrafluoroethylene (PTFE), the polymer of fluorinated ethylene propylene (FEP), the polymer of perfluoroalkoxy resin (PFA), or the polymer of ethylenetetrafluoroethylene (ETFE). Due to the properties of the fluorocarbon polymer material, the coating 14 provides the hose assembly 10 with the necessary resistance to both heat and chemical degradation while also bonding the braided layer 13 to the inner liner 12.

The coating 14 covers or coats the glass fibers of the braided layer 13. That is, the coating 14 covers the fibers of the braided layer 13 from the outer periphery radially inwardly. The coating 14, therefore, does not extend radially outward from the outer periphery of the braided layer 13. After the material has been coated, each fiber is discernable. In effect, what results is a coating 14 having a braided layer 13 therein.

The coating 14 is preferably formed by first braiding or wrapping the braided material 13 about the exterior of the inner liner 12. A dispersion containing a fluorocarbon polymer material, carrying agent, and surfactant therein, is then dispersed throughout the braided layer 13 from the outer periphery of the braided layer 13 radially inward toward the inner liner 12. The dispersion preferably comprises 50-60% solid fluorocarbon material (in fine granules or particles), preferably from one of the following: the polymer of tetrafluoroethylene (PTFE), the polymer of fluorinated ethylene propylene (FEP), the polymer of perfluoroalkoxy resin (PFA), or the polymer of ethylene-tetrafluoroethylene (ETFE). The dispersion preferably comprises 40-50% carrying agent. The carrying agent carries the solid fluorocarbon material through and about the braided layer 13. The preferred carrying agent is water, but other suitable carrying agents may be used. In order to keep the fluorocarbon material intermixed with the carrying agent and not from settling out between 0.1-10% by weight surfactant is preferably added to the dispersion. Although many surfactants may be used, such as FLUORAD FLUOROCHEMICAL FC171 (liquid) and FLUORAD FLUOROCHEMICAL FC143 (powder), sold by 3M, SILWETT 77 sold by Union Carbide has been found to work especially well.

The fluorocarbon polymer dispersion coats or is dispersed throughout the entire braided layer 13. Specifically, the fluorocarbon polymer dispersion effectively coats each of the glass fibers from the outer periphery radially inward. That is, the glass fibers are coated such that any gap between adjacent fibers will be filled with the dispersion. Also, the outer periphery of each fiber is completely coated. The carrying agent and surfactant are then removed from the dispersion by drying (heating) the hose assembly thereby leaving the fluorocarbon polymer material dispersed throughout the braided layer 13. The assembly is subsequently sintered to cure the fluorocarbon polymer material dispersed throughout the braided layer into a coating 14.

As previously stated, both the inner liner 12 and coating 14 are preferably fluorocarbon polymers. It is, however, not necessary that both the inner liner 12 and the coating 14 be of the same fluorocarbon polymer, although they may be. For example, the inner liner 12 may be made of PFA while the coating 14 is made of PTFE. Any combination of the fluorocarbon polymers previously listed may be utilized for the inner liner 12 and coating 14.

The coating 14 acts an adhesive to bond the braided layer 13 to the inner liner 12, thus, prohibiting slippage therebetween. Accordingly, the coating 14, in conjunction with the braided layer 13, allows the liner 12 to be bent without kinking. That is, the coating 14, dispersed throughout the braided layer 13, provides strength to the inner liner 12 upon bending. This is commonly referred to as hoop strength. Thus, by using a polymeric coating 14, dispersed throughout the braided layer 13, a trim profile assembly is produced which results in the hoop strength of the tubular member 11 being increased so that the hose assembly 10 can be bent without kinking the inner the liner 12. Further, the outer coating 14 adds to the working pressure of the hose. That is, the coating 14 provides strength and allows the inner liner 12 to accommodate a fluid under pressure. Also, the coating 14, due to the inherent properties of polymeric fluorocarbon materials therein hinders abrasion of the tubular member. Said another way, the coating 14 aids in the abrasion-resistance of the tubular member 11 and braided layer 13. Because the coating is continuous about the outer periphery of the braided layer 13, the braided layer is not subject to abrasion.

It is important that the dispersion be uniformly distributed about the braided layer 13 and about the inner liner 12 to ensure a secure bond between the inner liner 12 and the braided layer 13, while additionally offering the hose assembly sufficient protection against heat and chemical degradation and abrasion. The addition of the surfactant or wetting agent ensures proper distribution of the dispersion. Uniform distribution of the dispersion is of a particular concern when dealing with a solid fluorocarbon material and a liquid carrying agent dispersion due to fluorocarbon materials general lack of affinity for other materials. That is, due to the inertness of fluorocarbon polymers, they tend not to spread evenly throughout the braided layer 13 and about the inner liner 12. Additionally, solid fluorocarbon materials tend to settle out from liquid which they may be mixed with. Thus, the use of surfactants are paramount in the distribution of dispersions throughout the braided layer 13 and about the inner liner 12.

The assembly 10 further includes coupling means generally indicated at 20. The coupling means is for connecting the assembly 10 to a fitting (not shown). The fitting is adapted to cooperate with the coupling means 20. Specifically, the coupling means 20 comprises a coupling assembly 20. The coupling assembly 20 includes an insert portion, generally indicated at 22 for inserting into and engaging the interior of the inner liner 12. The insert portion 22 may have a plurality of barbs 24 for engaging the interior of the inner liner 12 (as best shown in FIG. 2). Alternatively, the insert portion may have a pair of annular ridges 26 and a smooth portion 28 therebetween, as best viewed in FIG. 3. The coupling assembly 20 further includes an engaging portion generally indicated at 30 extending longitudinally from the insert portion. The engaging portion is for engaging a fitting (not shown) and is adapted to cooperate therewith. The engaging portion 30 may comprise a male threaded member 32 (FIG. 2) or a female member 34 (FIG. 3). The engaging portion 30 may also comprise any configuration adapted to cooperate with a member to which it will be fixed. For example, the engaging portion 30 may comprise a socket to receive a mating ball joint. Finally, the coupling assembly 20 includes a locking collar 36. The locking collar 36 is disposed about the exterior of the outer coating 14 and is slid over the insert portion 22 of the coupling assembly 20. In this manner, the inner liner 12 is forced into tight frictional engagement with the insert portion 22 to prevent relative axial movement between the inner liner 12 and the insert portion 22. The coupling assembly 20 can be of any other well-known type. For example, the coupling assembly 20 may be of an organic polymeric material and may be molded about the tubular member 11 for a mechanical connection or fusion bond.

As fluid flows through the inner liner 12, electrical charges tend to build throughout the length of the inner liner 12. In order to prevent these electrical charges from accumulating, the inner liner 12 has an integral longitudinal conductive means coextensive with the length of the inner liner 12 for conducting an electrical charge along the liner 12. Preferably, the inner liner 12 has a conductive strip 16 of carbon black. The carbon black is electrically conductive and will dissipate any electrical charge build up by the fluid. Alternatively, the whole inner liner 12 can comprise the conductive means. This is done by using carbon black about the entire inner liner 12.

The braided layer 13 and coating 14 are preferably, electrically non-conductive. This is important in that electrical charges applied to the exterior of the coating 14 will not be conducted throughout the length of the tubular member 11 or to the fluid passing through the interior of the inner liner 12. It will be appreciated that other conductive material may be used to form the conductive strip 16.

The preferred method for making a hose assembly 10 as shown is as follows. An inner organic polymeric tubular member 12 is provided. Specifically, the inner tubular member 12 of a fluorocarbon polymer is extruded. A non-metallic or wound material (preferably glass fiber) is then braided or wound about the exterior of the inner liner 12 to form a braided layer 13. A dispersion containing a fluorocarbon polymer material, carrying agent, and surfactant therein is then applied throughout the braided layer 13 from the outer periphery radially inwardly toward the inner liner 12. Specifically, the inner liner 12 and braided material 13 are passed through a reservoir containing the dispersion. Alternatively, the dispersion may be sprayed onto the braided material. Although it is preferred that the dispersion contain the surfactant therein, the surfactant may be absent. If such is the case, the surfactant needs to be applied to the assembly by dipping the assembly in a reservoir containing surfactant or spraying the surfactant directly thereon. Preferably, the surfactant would be applied to the hose assembly prior to applying the polymeric fluorocarbon dispersion to the hose assembly. That is, regardless of whether the dispersion contains the surfactant therein, surfactant may be applied to the hose assembly prior to applying the dispersion thereto. For example, the inner tubular liner 12 may be dipped into a reservoir prior to positioning the braided layer thereabout.

Preferably, the dispersion is an aqueous one including a fluorocarbon polymer material therein. Because the dispersion is preferably aqueous, the preferred carrying agent is water. The dispersion is applied throughout the entire braided layer 13 and about the inner liner 12. The carrying agent and surfactant are then removed from the dispersion. Specifically, the assembly 10 is sent to a dryer (a preheated oven) which is preferably below the boiling temperature of the carrying agent (e.g., for water, below 212° F.). By utilizing an oven at a temperature below the boiling temperature of the carrying agent, a bubbling effect is avoided in the final product. The temperature can be above the boiling temperature, however, the assembly 10 may contain many air bubbles in the coating 14 if higher temperatures are used. Subsequently, the surfactant is removed from the dispersion by heating the assembly 10 as discussed above. Generally, higher temperatures are required to remove the surfactant than those required to remove the carrying agent i.e., usually 450-575° F. Thus, once the carrying agent and surfactant are removed from the dispersion, the fluorocarbon material is left dispersed throughout the braided material 13 and about the inner liner 12. The assembly 10 is then sintered at a suitable temperature (roughly 700° F.) to cure the fluorocarbon polymer material into a coating 14. Because glass fibers are used for the braided layer 13, the braided layer 13 is unaffected by the heat required to sinter the assembly 10. Finally, a coupling member 20 may be secured on one or both ends of the tubular member 11 to secure the assembly 10 to a fitting (not shown) for conducting fluid through the inner liner 12.

The invention has been described in an illustrative manner and it is to be understood that the terminology which has been used is intended to be in the nature of words of description rather than of limitation.

Obviously, many modifications and variations of the present invention are possible. In light of the above teachings, it is therefore to be understood that within the scope of the appended claims wherein reference numerals are merely for convenience and are not to be in any way limiting; the invention may be practiced otherwise than as specifically described.

What is claimed:

1. A method for constructing a hose assembly comprising the steps of:
providing an inner tubular liner (12) of a fluorocarbon polymer;
positioning a braided layer (13) about the exterior of the inner tubular liner (12);
said method characterized by the steps of;
applying a dispersion including a fluorocarbon polymer material (14) therein to the braided layer (13) and the inner tubular liner (12); and
applying a surfactant to the hose assembly (10) for distributing the dispersion throughout the braided layer (13) and about the inner tubular liner (12).

2. A method as set forth in claim 1 further characterized by applying the surfactant to the inner tubular liner (12) prior to positioning the braided layer (13) about the inner tubular liner (12).

3. A method as set forth in claim 2 further characterized by applying the surfactant to the inner tubular liner (12) by passing the inner tubular liner (12) through a reservoir containing the surfactant therein.

4. A method as set forth in claim 2 further characterized by applying the surfactant to the inner tubular liner (12) by spraying the surfactant about the inner tubular liner (12).

5. A method as set forth in claim 1 or 2 wherein the step of applying the dispersion throughout the braided layer and about the inner liner is further characterized by passing the inner tubular liner (12) with the braided layer (13) disposed thereabout through a reservoir containing the dispersion.

6. A method as set forth in claim 1 or 2 wherein the step of applying the dispersion throughout the braided layer and about the inner liner is further characterized by spraying the braided layer (13) positioned about the inner tubular liner (12) with the dispersion.

7. A method as set forth in claim 1 further characterized by the dispersion including the surfactant intermixed therewith.

8. A method as set forth in claim 1 or 2 further characterized by the dispersion including at least one carrying agent therein for carrying the fluorocarbon polymer material throughout the braided layer and about the inner liner (12).

9. A method as set forth in claim 8 further characterized by removing the surfactant and carrying agent from the hose assembly (10) subsequent to distributing the fluorocarbon polymer material throughout the braided layer (13) and about the inner tubular liner (12).

10. A method as set forth in claim 9 further characterized by heating the hose assembly to remove the surfactant and carrying agent therefrom.

11. A method as set forth in claim 10 further characterized by sintering the hose assembly (10) to cure the polymeric fluorocarbon material into a fluorocarbon polymer coating (14) dispersed throughout the braided layer (13) and about the inner tubular liner (12).

12. A method as set forth in claim 11 further characterized by utilizing a non-metallic material for the braided layer (13).

13. A method as set forth in claim 12 further characterized by utilizing glass fiber for the braided layer (13).

14. A method as set forth in claim 11 further characterized by forming the inner tubular liner (12) by extrusion.

15. A method as set forth in claim 7 further characterized by utilizing water as the carrying agent in the dispersion.

16. A method as set forth in claim 1 further characterized by securing at least one coupling member (20) on the hose assembly (10) for fastening the hose assembly (10) to a fitting.

17. A method as set forth in claim 1 further characterized by positioning an integral conductive means (16) coextensive with the length of the inner liner (12) to conduct an electrical charge along the inner liner (12).

18. A method for constructing a hose assembly comprising the steps of: extruding an inner tubular liner (12) comprising a fluorocarbon polymer material; positioning a nonmetallic braided layer (13) about the exterior of the inner tubular liner (12); passing the inner tubular liner (12) having the braided layer (13) thereon through a reservoir containing a dispersion including a fluorocarbon polymer material, water, and surfactant therein; heating the hose assembly (10) to removing the surfactant and water therefrom; and sintering the hose assembly (10) to cure the polymeric fluorocarbon material into a fluorocarbon polymer coating (14) dispersed throughout the braided layer (13) and about the inner tubular liner (12).

19. A method as set forth in claim 18 further characterized by applying the surfactant to the inner tubular liner (12) prior to positioning the braided layer (13) about the inner tubular liner (12).

20. A method as set forth in claim 18 further characterized by securing at least one coupling member (20) to the assembly for fastening the same to a fitting.
